(19) United States
(12) Patent Application Publication
(10) Pub. No.: US 2005/0285440 A1
(43) Pub. Date: Dec. 29, 2005

(54) Wheel traceability system

(76) Inventor: Pushpinder Singh Bal, Simi Valley, CA (US)

Correspondence Address: FULWIDER PATTON LEE & UTECHT, LLP, 200 OCEANGATE, SUITE 1550, LONG BEACH, CA, 90802, US

(21) Appl. No.: 10/876,162

(22) Filed: Jun. 23, 2004

(51) Int. Cl. B60B 3/10

(52) U.S. Cl. 301/63.101

(57) ABSTRACT

An identifying mark is disposed in a cast-in recess that is formed in a raw casting that is subsequently transformed into an automotive roadwheel. The mark provides for a unique identification to thereby allow the progress of each wheel through its manufacturing process to be monitored and its manufacturing history to be memorialized. The same identifying mark may be relied upon by the auto manufacturer for similar purposes and by matching each wheel's ID to VIN of the vehicle to which it is mounted, the end user should remain traceable throughout the wheel's service life. The recess is positioned so as to protect the mark disposed therein during the manufacturing process as well during its end use.

### FIELD OF THE INVENTION

The present invention generally relates to an identification system for automotive roadwheels and more particularly pertains to the marking of wheels so as to render each wheel uniquely identifiable during its manufacturing process as well as throughout its service life.

### BACKGROUND OF THE INVENTION

The process for manufacturing cast automotive roadwheels involves a large number of steps including, but not limited to, steps relating to casting, machining, heat treating and finishing as well as a multitude of quality control inspections that are performed throughout the process. In an effort to control the progression of the manufacturing process, some wheel manufacturers rely on various stamps that are applied to the wheel after certain steps or inspections have been completed. By requiring a particular mark to be present before a successive step will be undertaken, some control over the entire process is achievable. However, while such system could theoretically prevent, for example, a raw casting from inadvertently being passed on to a machining step without having undergone an inspection or from inadvertently being finished prior to heat treatment, a number of disadvantages are nonetheless inherent therein.

Reliance on a series of stamps in an effort to control the manufacturing process can be susceptible to operator error or abuse to the extent that the absence of a stamp may be overlooked or ignored or a stamp that is visible may be misinterpreted. The finished wheel may offer no evidence that all manufacturing steps and inspections had in fact been completed, let alone when each step was completed, on which production line and/or by whom. Additionally, the steel or ink stamping of wheels is rather labor intensive, certain wheels are difficult to stamp due to wheel geometry and the resulting marking may not be legible or only partially legible. While some wheel manufacturers additionally, or alternatively, rely on the use of cast-in calendars, such insignia can do little more than identify the date on which the wheel was cast, a date which can conceivably be shared with a very large number of wheels. A marking system is needed which allows an individual wheel's progress through the manufacturing process to be monitored and the specifics of its manufacturing history to be memorialized.

An additional shortcoming inherent in the described stamping or calendaring practices is that only a very minimal amount of information can thereby become associated with an individual wheel. This dearth of information substantially frustrates attempts to trace with any precision a wheel's manufacturing history or its whereabouts during its service life. Tracing a wheel from a particular manufacturing step to an end user or from an end user to a particular manufacturing step is all but precluded. As a consequence, in the event it is determined that a flaw or error in a particular stage of the manufacturing process necessitates the recall of all wheels similarly situated, a much greater number of vehicles would have to be recalled in order to ensure that all of the affected wheels are in fact attended to. Conversely, if a failure during the service life of a wheel indicates that a manufacturing defect may be involved, the circumstances of that particular wheel's manufacture would not be ascertainable and hence, the identification of wheels similarly situated would be very difficult. A marking system is therefore needed that allows a particular wheel to be linked to a VIN to thereby facilitate tracing both forward to an end user and backward to the specifics of its manufacture.

Due to the high cost of modern alloy wheels, such wheels are susceptible to theft. Without a unique marking on each wheel, a particular wheel cannot be linked to a particular vehicle. Thus, a stolen wheel can be used and sold without concern. A marking system is therefore needed that deters theft.

Ideally, a marking system is needed that renders each wheel fully traceable so as to simultaneously allows its progress through the manufacturing process to be monitored, its manufacturing history to be memorialized and its whereabouts upon being passed on to an automobile manufacturer and on to the end user to be ascertained. The marking of the wheel should be capable of being applied as early in the manufacturing process as possible and preferably by an automated process, should be able to survive the entire manufacturing process in tact, should be machine-readable and should be adequately protected and capable of surviving throughout its entire service life.

### SUMMARY OF THE INVENTION

The present invention provides for the permanent marking of automotive roadwheels so as to render each wheel individually identifiable throughout the process of its manufacture as well as throughout its service life. Such identification system provides benefits for the wheel manufacturer and the automobile manufacturer as well as the end user. The wheel manufacturer is thereby able to gain the ability to more tightly control inventory, to monitor progress throughout each wheel's various manufacturing steps, and to more efficiently address quality control issues both before and after distribution of the finished wheel. The automobile manufacturer in turn thereby similarly stands to gain the ability to more tightly control inventory as well as quality. Once in service, additional benefits are realizable to the extent that should a wheel fail, the specifics of its manufacturing history can easily be traced. Conversely, should a recall of wheels become necessary, individual automobiles to which the wheels have actually been mounted can readily be identified for recall by correlating wheel IDs with VINs, thereby obviating the need to recall an excess number of automobiles in order to ensure full recovery of the defective wheels. A uniquely identified wheel can additionally provide benefit with regard to theft deterrence as a mutilated or defaced wheel ID or one that is altered and fails to correlate to the VIN of the vehicle to which it is mounted would invite investigation and may therefore have an adverse effect on the market for stolen wheels.

A wheel manufactured in accordance with the present invention, has a unique identifying marking formed therein, applied thereto or otherwise disposed thereon as early in the manufacturing process as possible, preferably immediately after the casting step. In a preferred embodiment, the raw casting includes at least one cast-in recess wherein such recess is dimensioned to receive the identifying marking. The recess is formed in a location that serves to protect the identifying marking during the manufacturing process and with sufficient depth to preclude contact between the identifying marking and the machining tools that are brought to bear against the casting during the machining process. The location of the recess is additionally selected so as to ensure that the identifying marking is protected during the service life of the wheel. Most preferably, the recess is located on the wheel's tire side and more specifically on the side of the drop center. Such location is preferred as it is consistent from wheel design to wheel design and thereby facilitates both the marking of the wheel as well as the subsequent the reading of the marking. Moreover, because this area of the wheel will become covered by the tire that is mounted to the wheel, the marking will be protected from the elements and should remain readable throughout the wheel's service life. This location also serves to preserve the aesthetics of the wheel as it will be hidden from view due to the presence of the tire. An additional benefit associated with this location is that a thief would have to expend the effort to separate the wheel and tire to alter or obliterate the marking or to merely check for the presence of an identifying marking to thereby further deter at least the casual thief.

The present invention additionally provides for two such recesses to be formed in the wheel casting, preferably in the side of the drop center and preferably spaced apart by 180°. The 180° spacing has the effect of automatically canceling any adverse effect a single recess may have on the balance of the wheel. The accommodation of two markings is additionally beneficial to the extent that a redundancy ensures that the wheel continues to be identifiable should one marking be or become unreadable. Additionally, the application of two markings allows two different systems to be used, for example one that is machine readable such as for example a bar code and a second that is readable without a machine such as an alphanumeric designation. This thwarts alteration as a discrepancy between an altered alphanumeric designation and a non-corresponding bar code would be ascertainable.

A wheel of the present invention is manufactured with the initial casting of a raw form that preferably includes the two identically dimensioned cast-in recesses spaced 180° apart. As soon as is practicable, the identifying marking or markings are applied to the recessed surface including but not limited to the etching, chiseling, stamping or laser marking a metal surface in the recess or the attachment of a tag to a surface in the recess. Such tag may have optically readable information thereon or may comprise an RFID tag. The optically readable information may take the form of an alphabetic, numeric or alphanumeric designation, may comprise a bar code or 2-D matrix marking or any of a multitude of other identifying marks that would serve to provide a unique marking for each wheel.

Once the identifying mark is in place, the raw casting is subjected to the normal succession of heat treating machining, and finishing steps as well as the various quality control tests and inspections there between to yield a finished automotive roadwheel. The identifying mark may be read at each manufacturing step that the wheel is subjected to along the way and the specifics of such step recorded to enable a complete record of its manufacture to be compiled, preferably by a computerized process. The data not only provides a record for future reference but may also be relied upon to ensure that a certain protocol is followed. To such end, a computer that is relied upon to coordinate the manufacturing process would issue an enable-command to a particular handling, conveying and/or processing device only if such step is appropriate for a particular wheel. Such system thereby automatically precludes the skipping or unnecessary repetition of any of the multitude of steps involved in the manufacture of a wheel. By monitoring the progress of each wheel throughout the manufacturing process, its precise location on the shop floor should also be readily ascertainable.

Once the manufacturing steps have been completed, the identifying marks may again be relied upon during the shipping of the wheels to an automobile manufacture. The wheel manufacturer may also rely on the same identifying marks to keep track of the wheels in the factory and eventually match the wheel IDs with the VIN of the vehicle to which the wheels are mounted. Such information may or may not initially be shared with the wheel manufacturer.

The location of the identifying mark within the recess formed in the side of the drop center serves to protect the mark during machining process wherein the mark is located at a depth below the anticipated cut imparted to the surrounding surface during the machining process. During the application of paint, the marking may be temporarily masked or its three dimensional character may be sufficient to ensure readability despite coatings of paint. The location of the marking within a recess on the side of drop center also protects the marking during the tire mounting operation as the tire bead is supported by the surrounding surface as it is drawn there across to the bead seat.

These and other features and advantages of the present invention will become apparent from the following detailed description of preferred embodiments which, taken in conjunction with the accompanying drawings, illustrate by way of example the principles of the invention.

### BRIEF DESCRIPTION OF THE DRAWINGS

FIG. 1 is a curb-side view of an automotive roadwheel of the present invention; and

FIG. 2 is a cross-sectional view taken along lines 2-2 of FIG. 1; and

FIG. 3 is a perspective of the wheel shown in FIG. 1.

### DETAILED DESCRIPTION OF A PREFERRED EMBODIMENT

The present invention provides for the application of a unique identifying marking to an automotive roadwheel as early during the manufacturing process as is practicable and in such a manner so as to ensure that the marking remains legible throughout the balance of the process as well as throughout its service life. By imparting a unique identity to each wheel, the progress of each wheel through its manufacturing process can be monitored, controlled and memorialized and its path through the stream of commerce can be traced. By matching wheel ID with the VIN of the vehicle to which it was mounted, the end user of a particular wheel can be identified, and conversely, the manufacturing history of a particular end user's wheel can be summoned. The following description is directed to one preferred embodiment of the present invention.

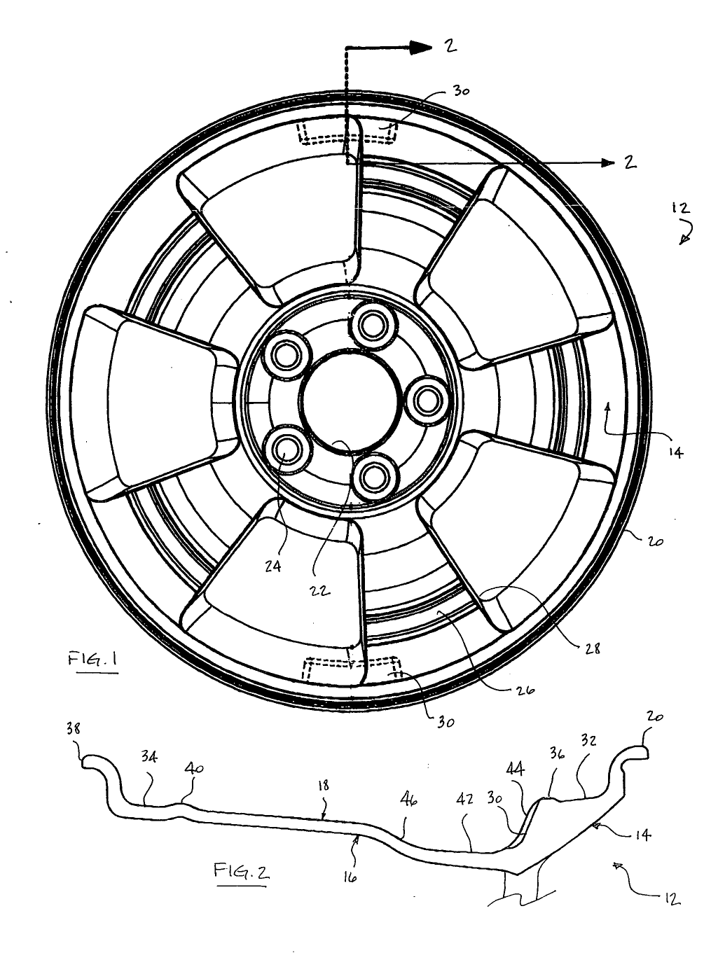

FIG. 1 is a curb-side view of a wheel 12 of the present invention. A roadwheel's curb side 14 is that which is visible when mounted on a vehicle while its brake-side 16 is the side opposite thereto that faces inwardly. The wheel's tire-side 18 is the circumferential surface which is covered by a tire that is mounted to a wheel. Visible in the Figure are the wheel's outer flange 20, the center bore 22 and the lug holes 24. The wheel can of course have any ornamental design which in this case, for illustrative purposes only, comprises a five spoke pattern wherein five spokes 26 alternate with five voids 28. Shown in phantom are two recesses 30 that are formed in the tire-side of the wheel. The two recesses are identical to one another, are each dimensioned to receive an identifying marking therein and are positioned so as to be diametrically opposed to one another, i.e. with a spacing of 180°, wherein such spacing serves to cancel any adverse effect on the rotational balance a single recess may have on the wheel.

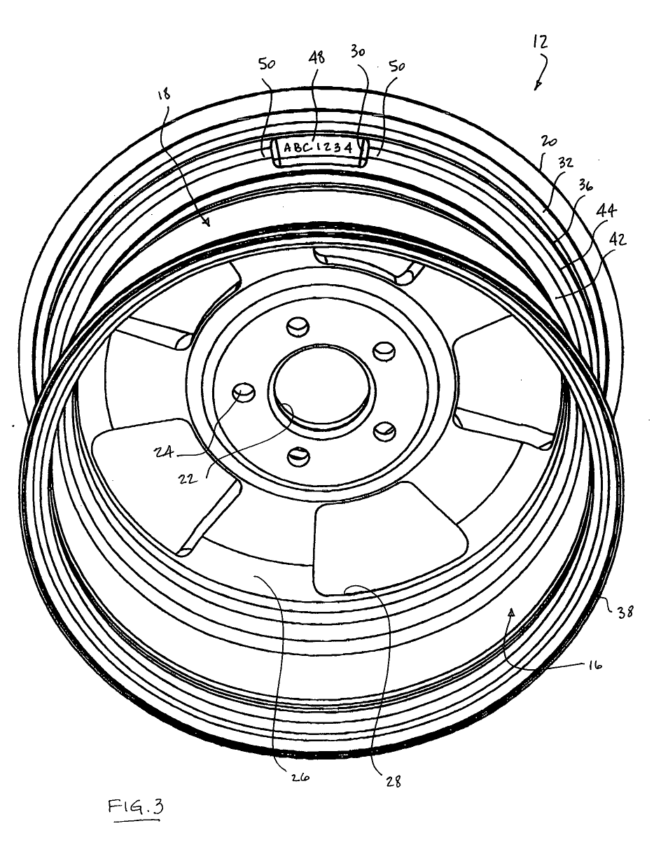

FIG. 2 is a cross-sectional view taken along lines 2-2 of FIG. 1 to more precisely show the positioning of one of the recesses 30 that is disposed on the tire-side 18 of the wheel. The tire-side includes an outboard bead seat 32 and an inboard bead seat 34. Each bead seat is flanked by a corresponding flange and a hump. Accordingly, the outboard bead seat 32 is flanked by the outboard flange 20 and hump 36 while the inboard bead seat 34 is flanked by the inboard flange 38 and hump 40. The wheel additionally includes a drop center 42 which comprises a region disposed between the outboard and inboard humps having a reduced diameter which facilitates the mounting of a tire to the wheel. In the particular wheel configuration that is shown, the drop center has relatively steep sidewall 44 on the outboard side of the drop center, and an inboard sidewall 46 of substantially shallower slope. The substantially greater thickness of wheel material immediately adjacent to the outboard sidewall of the drop center renders this region ideal for accommodating the recesses 30. An additional benefit inherent in locating the recess in the sidewall of the drop center is that it is easily cast without the need for complex molding operations. The location and a shape as is shown in FIG. 2 allows the mold segment to be freely pulled clear of the raw casting. The recess in the finished wheel preferably has dimensions of about 3.0 in length, ¾″ in height and a maximum of about ⅛″ in depth.

FIG. 3 is a perspective view of the wheel 12 of the present invention showing both its tire-side 18 as well as its brake-side 16. The recess 30 is shown formed in the outboard sidewall 44 of the drop center 42. Additionally visible is the identifying marking 48 that has been formed in, applied to or otherwise disposed in the recess. By selecting this particular location for the recess, interference with the tire mounting operation is avoided as the surface of the outboard sidewall immediately adjacent 50 to the recess can be relied upon to support the tire bead of a tire as it is forced up the sidewall onto the bead seat 32.

The indicia used to uniquely identify each wheel can comprise any identifying system that can be accommodated within the recess including, but not limited to, alphabetic, numeric or preferably alphanumeric characters as well as bar code or 2-D matrix representations thereof. Alternatively, an RFID tag may be attached to the wheel within the recess. In a preferred embodiment, one recess accommodates a series of alphanumeric characters while the second recess accommodates a bar code that corresponds to the alphanumeric designation.

The indicia may be formed directly in the metallic surface of the recess or may be disposed on a tag that is in turn attached to a surface within the recess. Various processes are available for forming an indelible marking in the metal including but not limited to engraving, chiseling, stamping or laser marking to yield a series of marks. A process is preferred that results in a three dimensional depiction wherein individual characters either extend into the surface or are raised relative to the surrounding surfaces. In the most preferred embodiment, a machine driven chiseling tool is brought to bear on the back surface of the recess that quickly imparts the selected identifying marking to such surface. This particular marking method is preferably adapted to leave an impression that is about 0.015 deep and ¼″ wide wherein a 7 character alphanumeric designation can be created in about 6 seconds.

The manufacture of wheel in accordance with the present invention requires the modification of the wheel mold so as to form the desired recesses in the raw casting. As soon after the raw casting is removed from the mold as is practicable, a unique identifying marking is imparted to the surface of the recess. All information relating to the forming of the raw casting, including for example the date, the production line, wheel style and size, and alloy is initially recorded in association with the unique marking. The marking is read at selected subsequent manufacturing steps for the purpose of recording information relating to each such steps and/or for the purpose of determining whether subjection to a particular step is warranted in view of the wheel's manufacturing history. As an example, a computer may be relied upon to issue a command to prevent a particular operation from being performed if information relating to a previous inspection is either missing or indicates that the workpiece should have been rejected. The database that is gradually built up with respect to each wheel may not only be relied upon for the purpose of monitoring or controlling the manufacturing process but additionally allows a manufacturer to keep a running inventory of all workpieces on the shop floor. Once the finished wheel is passed on to an automobile manufacturer, similar advantage can be taken of the unique marking to keep track of inventory and continue to create a record. Linking a wheel ID with the VIN of a vehicle would allow the wheel to be traced throughout its service life.

While a particular form of the invention has been illustrated and described, it will also be apparent to those skilled in the art that various modifications can be made without departing from the spirit and scope of the invention. More particularly, other locations on the raw casting can be modified to accommodate an identifying mark, wherein such mark is able to at least survive the manufacturing process and preferably the wheel's entire service life. Additionally, any of various well known identification systems and marking methods may be employed. Accordingly, it is not intended that the invention be limited except by the appended claims.

1. An automotive roadwheel, comprising:
a casting having formed therein a cast-in recess; and
a marking unique to said wheel disposed in said recess, said recess being positioned and formed such that said marking disposed within said recess is precluded from being contacted by machining tools during said wheel's manufacture and protected by a tire mounted to said wheel during the wheel's service life.

2. The roadwheel of claim 1, wherein said wheel has a curb side, a brake side and a tire side and said cast-in recess is formed in said tire side.

3. The roadwheel of claim 2, wherein said tire side includes a bead seat and a drop center and said recess is formed in a transition zone disposed between said bead seat and said drop center.

4. The roadwheel of claim 2, wherein a second recess for receiving a marking is formed 180° offset relative said first recess.

5. The roadwheel of claim 4, wherein said markings are identical.

6. The roadwheel of claim 4, are different.

7. The roadwheel of claim 6, wherein one marking comprises an alphanumeric designation.

8. The roadwheel of claim 7, wherein the other marking comprises a bar code, 2-D matrix.

9. The roadwheel of claim 1, wherein said marking is formed in a surface of said recess.

10. The roadwheel of claim 1, wherein said marking is formed in a tag that is attached to a surface of said recess.

11. The roadwheel of claim 10, wherein said marking comprises an RFID tag.

12. A method of tracing an automotive roadwheel during its manufacture and during its service life, comprising:
forming a raw casting so as to include a cast-in recess, positioned and
dimensioned so as to preclude a surface therein from being machined during machining of said casting; and
disposing an identifying mark unique to said roadwheel on said surface in said recess.

13. The method of claim 12, wherein said roadwheel has a curb side, brake side and tire side and wherein said recess is formed so as to be located in said tire side.

14. The method of claim 12, wherein said identifying mark comprises an alphanumeric designation.

15. The method of claim 12, wherein said identifying mark comprises a bar code.

16. The method of claim 12, wherein said identifying mark comprises a 2-D matrix.

17. The method of claim 12, further comprising subjecting said raw casting to a series of steps of a manufacturing process for providing a finished roadwheel, wherein said identifying mark is read at selected steps.

18. The method of claim 17, wherein information relating to said selected steps is recorded in association with said identifying mark.

19. The method of claim 17, wherein the performance of successive steps is an enabled as a function of information recorded with respect to previous steps.

20. The method of claim 18, wherein information relating to a vehicle to which said finished roadwheel is mounted is recorded.

21. The method of claim 18, wherein all information relating to a particular wheel is recorded in a single database.
